(19) United States
(12) Patent Application Publication
(10) Pub. No.: US 2019/0145794 A1
(43) Pub. Date: May 16, 2019

(54) System and Method for Predicting Hyper-Local Conditions and Optimizing Navigation Performance

(71) Applicant: WINNING ALGORITHMS INC., Portsmouth, NH (US)

(72) Inventor: Robert D. KETCHELL, III, Portsmouth, NH (US)

(21) Appl. No.: 16/095,141

(22) PCT Filed: Apr. 21, 2017
(86) PCT No.: PCT/US2017/028920

§ 371 Date: Oct. 19, 2018

Related U.S. Application Data
(60) Provisional application No. 62/325,585, filed on Apr. 21, 2016.

(51) Int. Cl. G01C 21/36; G08G 1/0968; G05D 1/02; G01C 21/34

(52) U.S. Cl. CPC G01C 21/3697; G08G 1/096844; G08G 1/096838; G01C 21/3691; G05D 2201/0213; G01C 21/3415; G01C 21/3667; G01C 21/3469; G01C 21/3461; G05D 1/0212

(57) ABSTRACT

Systems and methods for predicting conditions along a course are provided herein. The disclosed techniques utilize data from multiple sources and adjust the data using calibration methods to provide hyper-local course predictions. Hyper-local course predictions are then grouped based on an assigned risk score to yield course segments with similar risk profiles. Information regarding predicted risks for various course segments is then transmitted to a user, possibly with accompanying alert and/or advisory action information to optimize navigation performance.

### CROSS REFERENCE TO RELATED APPLICATION

This application claims benefit of U.S. Provisional Application Ser. No. 62/325,585, entitled, “A System for Alerting an Individual to Risks when Traversing a Route” filed Apr. 21, 2016, the entire disclosure of which is incorporated herein by reference.

### BACKGROUND

Some navigation tools currently exist to assist travelers in selecting a route. For example, various global positioning system (GPS) devices allow a user to select a route based on limited parameters, such as the shortest route, a route with the least amount of current traffic, or a route that avoids tolls.

### BRIEF DESCRIPTION OF THE DRAWINGS

FIG. 1 is a flow chart illustrating an exemplary system for course prediction and navigation, in accordance with some embodiments of the subject disclosure.

FIG. 2 is an exemplary method of course prediction and traversal, in accordance with some embodiments of the subject disclosure.

FIG. 3 is a diagram showing an exemplary scouting device traversing a course, in accordance with some embodiments of the subject disclosure.

FIG. 4 is a diagram showing an exemplary decision tree for adjusting raw data for a course, in accordance with some embodiments of the subject disclosure.

FIG. 5 is an illustration of exemplary waypoint nodes for a route, in accordance with some embodiments of the subject disclosure.

FIG. 6 is an illustration of exemplary environment nodes for a route, in accordance with some embodiments of the subject disclosure.

FIG. 7 is an exemplary user display showing a start menu, in accordance with some embodiments of the subject disclosure.

FIG. 8 is an exemplary user display showing a map, in accordance with some embodiments of the subject disclosure.

FIG. 9 is an exemplary user display showing an alert message, in accordance with some embodiments of the subject disclosure.

FIG. 10 is an exemplary user displaying showing an alert message and possible actions, in accordance with some embodiments of the subject disclosure.

FIG. 11 illustrates an exemplary computer system, in accordance with some example embodiments.

### DETAILED DESCRIPTION

Techniques are disclosed for selecting a course from various possible courses or modifying behavior based on predicted course conditions and effects thereof. While some tools currently exist to assist a traveler or vehicle in selecting and negotiating a route, there are currently no tools available that reliably assess current course conditions, particularly conditions resulting from weather, and predict environmental conditions, accident risk, fuel consumption, and other relevant information that result in increased precision of travel. Additionally, current systems do not include weather information as a user is traversing a route, including relative impact of current weather conditions, or features to display predicted or current risks in high resolution.

For example, currently available route selection tools react to traffic conditions after they develop and are unable to predict routes that may develop traffic conditions during travel of the route. Additionally, the route selection tools currently available do not account for weather conditions along the route, such as dangerous weather conditions, including the road surface condition or winds affecting navigation, which could impact travel time and/or safety of the route. Compounding this issue, currently available route selection tools do not consider elevation changes along the route or wind conditions that may affect route safety and/or fuel consumption. Indeed, many available route selection toots do not provide estimated fuel consumption for different routes and, in situations where estimated fuel consumptions are provided, the estimates are crude and do not consider road conditions or other critical information in the calculation (such as high resolution wind conditions in varying geographic regions).

Course mapping and selection methods and systems are disclosed herein that provide highly accurate predictive information regarding possible courses to travel from a designated origin to a selected destination or the methods of which to modify the way the course is negotiated. As described below in additional detail, the disclosed systems and methods may allow a user to evaluate course conditions of various possible courses and ultimately select a course that is preferable, given the user's preferences, or determine the best possible method for navigating a selected course. Additionally, the disclosed systems may, in some embodiments, provide updates during travel of a particular course, as appropriate, allowing a user to select an alternative course segment if course conditions change during course traversal, or modify the prescribed methods of travel. The disclosed methods and systems may be used in various circumstances for numerous purposes, as desired by a user and discussed below in detail.

### General Overview

The disclosed methods and systems are different from other systems and methods in many aspects. For example, the disclosed techniques use highly accurate and calibrated data from a system that samples the data directly and develops specific correction factors that differ depending on the geo location to predict the risk associated with course conditions and/or vehicle performance along a course. In order to do that, the disclosed systems require accurate data and the ability to calculate relative measurements, such as when a course is currently being traversed by a vehicle in motion. No other system considers the effect of movement and weather or the environment as it relates to the geo location, including features surrounding the geo location, rather, currently available systems only calculate the effect of weather at a fixed position or on a static object, which does not allow for control of the system either voluntarily or involuntarily. The disclosed techniques, however, can combine weather and environmental data with geographical features into a route navigation system with precision beyond the capabilities of other systems.

The disclosed systems may also derive a highly accurate dataset from calibration of interpolated values using a measurement device that may be fixed on vehicles, bicycles, and/or people. Using this device, the disclosed systems can measure differences in weather information and road conditions along a route caused by geographical features (either naturally occurring or man-made) and can thereby develop calibration equations or rules to correct the data at each interpolated point. In some embodiments, the measurement device includes an accelerometer, microprocessor, flash storage, Bluetooth wireless communication, and/or input ports for sensors such as dynamic pressure, thermistor, barometric pressure, relative humidity sensors, and sonic sensors for wind speed and wind direction.

Furthermore, the dataset derived by the disclosed system allows for more advanced calculations to determine the effect of traveling along a route at a given time, either prior to traveling through a waypoint, in real-time, or prior to passing through a waypoint. Predictions can thus be made on course conditions and performance along a route (in three dimensions). The risk for each scenario can be determined as the probability that an outcome such as rain, heat exposure, high speed cross winds, or a steep elevation profile is likely to occur. A high risk course may mean, in some embodiments, that there is a strong chance of a negative outcome that impairs safety, efficiency, and/or performance. A low risk course may mean, in some cases, that a negative impact is not likely to occur. The classification of risk can be used to describe a complete course or a section of a course, referred to as a grouping. The classification of risk can range from any range of numerical classification, not just limited to low or high.

As the calculations performed by the disclosed systems may be computationally taxing, the amount of data produced can make the memory capacity in mobile devices and small computers prohibitive. In order to calculate these risks and handle large amounts of data, the disclosed system may use techniques to arrange the results into groupings. These groupings can be used to display course segments where there is a low, moderate, or high risk. In some embodiments, groupings can contain nested information compressed in a form that can be transferred between devices more efficiently. These groupings of compressed information may contain the results from calculations that derive metrics, which represent something broader and more meaningful, such as risks along a road segment. In embodiments where risk calculations happen in the cloud, risk groupings may be sent to personal computers and/or mobile devices or any device connected to the Internet, which allows a user to view the risk groupings, and take action, if desired. Unlike other data interpolated along a road segment, instead of being raw weather and environmental data, risk groupings more particularly identify risk along a given course segment.

The disclosed methods and systems can calculate risk associated with a given course segment rather than an entire route, thereby allowing a user to alter a small part of their route rather than adjusting the entire route. The disclosed systems provide high-resolution data and utilize risk groupings to allow a user to make a better and more secure choice or modify existing methods to travel the same course. In some embodiments, the disclosed systems include an additional feature that uses online sites and applications, including, for example, social media data, to determine the accuracy and validity of weather and environmental data provided. This unstructured data can be gathered via software techniques, such as web-scraping and datamining, parsed into meaningful and structured data, and stored in a repository. In addition, the disclosed systems can also include a feature that collects data from online sites, applications, and social media users over time and weights their data based on the amount of accurate information posted to ensure only verified information is provided by the system.

The disclosed methods and systems may be utilized for any event that happens in an open environment. In contrast to events that occur in closed settings such as baseball, football, or basketball, which can be monitored with video, to allow spectators in the closed setting to see everything that is happening during a game or event, in an open environment, it is not possible to monitor the event with a single input, such as TV footage. Using the postings of different people along a route can, in some circumstances, enable the disclosed systems to better capture what is happening throughout the event, or course. This information can then be used to improve the calculations of risk groupings for the course.

The disclosed systems and methods can be used for any desired application, such as autonomous vehicles and/or drones. As used herein, the term “autonomous” refers to any device or vehicle capable of sensing its environment and navigating without human input. In some cases, “autonomous” vehicles are fully autonomous, requiring no human input, or partially autonomous in that they are capable of receiving human input. As used herein, the term “drone” refers to either fully or partially autonomous drones or remote-controlled drones operated by a human. In some cases, the disclosed methods may also be used for sports, including cycling, where wind and weather conditions affect energy expenditure and rate of fatigue. In cycling, as in other sports, traveling from the start of the race to the finish line as efficiently and safely as possible is crucial to the athlete's performance. By way of example, the disclosed systems and methods may be used in connection with any of the following activities: skiing, snowboarding, mapping, automotive, boating, alternative energy, self-driving vehicles, sailing, car racing, triathlons, cycling, running, logistics and shipping, maritime, weather analysis, applied ballistics, agricultural, fitness devices, social media, simulation software, product development, drones, and/or entertainment. As will be understood, the terms “course” and “route” may be used, at times interchangeably, throughout the subject disclosure to refer to physical space traversed from an origin to a destination (e.g., on a road, a trail, a track, in water, in air, in space, and so on). Additionally, as used the in the subject disclosure, the term “vehicle” includes any suitable type of moveable object, including but not limited to driver-operated vehicles, autonomous (or driverless) vehicles, cars, trucks, buses, trains, boats, aircraft, vessels, drones, and other conveyances.

In some particular example embodiments, the disclosed methods and systems may be used to assist partially and fully autonomous vehicles/devices while travelling a course. In some such embodiments, course classification module 300 may generate hyper-local course predictions pertaining to road surface and/or wind conditions along a course. In these and other embodiments, the device or vehicle may also be equipped with a sensor (e.g., a wind sensor) to measure environmental conditions experienced (e.g., wind speed and/or wind direction) while travelling the course. The measured environmental conditions (for example, wind speed) may be compared to the hyper-local course predictions for various purposes. For example, comparing the measured environmental conditions to the hyper-local course predictions may confirm whether the vehicle or device is on course or whether a course correction adjustment is needed to move the vehicle or device back to the course. In some embodiments, the measured environmental conditions and hyper-local course predictions may be used to determine the vehicle or device's velocity and/or distance travelled. For example, in some cases, dead reckoning techniques may be used in conjunction with the disclosed systems to calculate velocity and/or distance travelled. Numerous configurations and variations will be apparent to one of skill in the art upon consideration of the subject disclosure.

The disclosed methods and systems can be used to improve the performance of how people and products get to their destination, regardless of the mode of transportation. In some embodiments, the disclosed methods can be implemented with one or more cloud-based software applications. For example, in some embodiments, a cloud-based software code application configured in accordance with the subject disclosure may, in some embodiments, aggregate data points, while in motion, along a route and predict collective emergent patterns as they relate to safety, efficiency, and/or performance. The software may connect with external Application Programmable Interfaces (APIs) that acquire waypoints, traffic data, weather data, and/or other environmental information, or it may connect to a repository with previously stored data. Multithreading and advanced computing techniques may, in some cases, allow for fast processing of this data. Collective emergent patterns can then be predicted, in some example embodiments, to provide a user with a preferred course for driving, commuting, cycling, running, boating, delivering, or any other means of transportation or movement, and the pattern of the movement from origin to destination. The disclosed methods and systems can be used for virtually any type of travel, including automotive travel, flight, rail travel, boating, snowboarding, skiing, cycling, swimming, running, underwater travel, or any other travel in physical space. Furthermore, the disclosed methods and systems can be employed in one or more of the following technology areas: self-driving cars, shipping, fleet management, racing, applied ballistics, maritime activities, social media, entertainment, map integration, alternative energy, weather analysis, agriculture, simulation software, fitness devices, delivery services such as drones, and/or product development. The disclosed technologies can be used in static environments (e.g., for objects in a fixed position) or for objects in dynamic motion. Numerous variations and possibilities will be apparent to those skilled in the art in light of the subject disclosure.

### Methodology

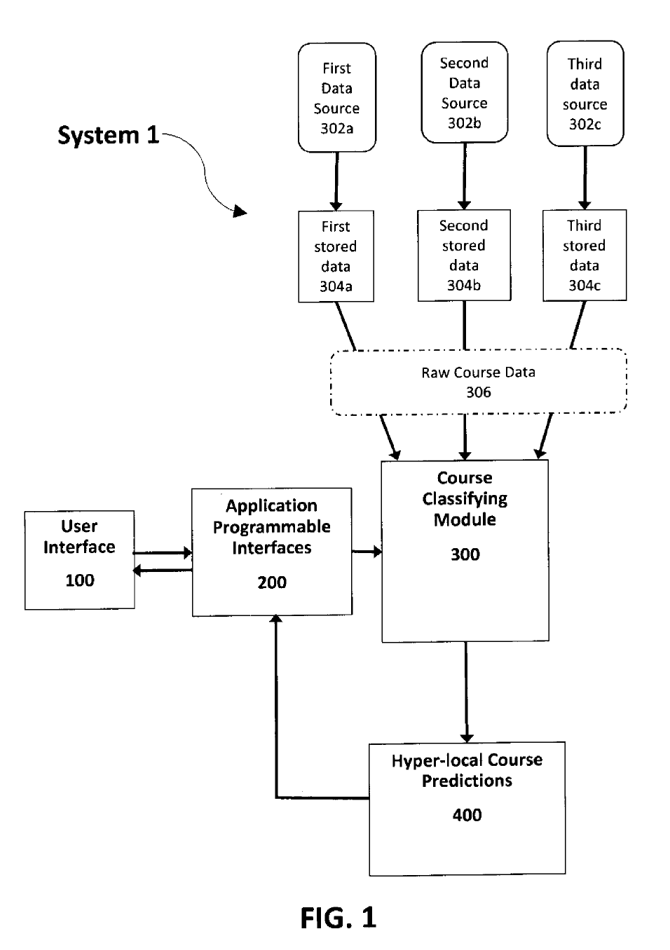

As described below in detail, the disclosed methods can be implemented with various systems. FIG. 1 illustrates a possible configuration for a course prediction and navigation system 1, where a user interface 100 is connectable to one or more application programmable interfaces 200, which communicate with a course classifying module 300. The user interface can be unique to the disclosed system or may, in some cases, be provided by a third party application that interfaces with the disclosed system. As described in detail below, in some embodiments, course classifying module 300 can be configured to analyze raw course data of various possible courses and to provide hyper-local course predictions 400 that are then transmitted to the user interface 100 through the application programmable interface 200.

In some embodiments, a user may begin by providing an origin and a destination in the user interface 100. The origin and destination may be provided in any suitable format, including but not limited to, a street address, latitude and longitude coordinates, or a place of interest. In some cases, a user may input one or more possible courses into the user interface 100 using latitude and longitude paired lists, such as in any of the following file formats: GPX, TCX, KML, KMZ, XML, CSV, TXT, and JSON. Additional information, such as parameters for a preferred course (e.g., fastest route or lowest accident risk) and/or vehicle specifications or mode of travel (including but not limited to type of vehicle, such as car, truck, SUV, bike, drone, train, boat, or no vehicle, and/or vehicle weight) may also be input into user interface 100, in some example embodiments. In some embodiments, the disclosed system can be used without a user interface. In some such embodiments, interaction with the course classification module 300 may occur directly through the API, which may receive data, rather than a visualization. Example systems that may not utilize a user interface 100 include but are not limited to autonomous vehicles and/or drones.

User interface 100 can provide visual information regarding one or more courses. For example, in some embodiments, user interface 100 may display course segments of a course as colored groupings. In this way, the user interface 100 can allow a user to visualize predicted conditions along a course, or segments of a course, or visualize past hyper-local conditions. In these and other embodiments, a user can interact with possible courses and course segments to select a course or course segment with the best predicted or past calibrated conditions by evaluating the hyper-local conditions in each course segment of a particular course.

As illustrated in FIG. 1, application programmable interface(s) 200 may interact with user interface 100 and course classifying module 300. In some example embodiments, an application programmable interface 200 may receive information pertaining to a course origin and destination from the user interface 100 and may then send this and possibly other information to a course classifying module 300. In these and other embodiments, an application programmable interface 200 may also be configured to receive information from course classifying module 300. Information received from course classifying module may include, in some cases, predicted outcomes of various courses, course groupings, alerts for a course, and/or recommended actions to accompany an alert.

Course classifying module 300 may be configured to receive a signal from application programmable interface(s) 200. For example, in some example embodiments, course classifying module 300 may receive an origin and destination and derive possible courses from the origin to the destination. The course classifying module may also provide conditions for a course of travel without a destination provided, may predict a destination, or may tell the user the best course conditions to travel from the origin, without a particular destination specified. Course classifying module 300 may access raw data from either external or internal data sources and retrieve raw course data for the possible courses derived. FIG. 1 illustrates three external data sources 302a, 302b, 302c and three internal data sources 304a, 304b, 304c that may be used to provide raw course data to course classifying module 300. External data sources 302a, 302b, 302c may be any data source external to the course classifying module 300, such as data from the national weather service. Internal data sources 304a, 304b, 304c may be any data source internal to the course classifying module 300, such as, for example, accident records, population density, geographical features, climate conditions, or other stored information. Course classifying module 300 may access one or more external and/or internal data sources to generate course predictions. In some embodiments, course classifying module 300 may access at least one, at least two, at least three, at least four, or any suitable number of external and/or internal data sources to generate predicted course conditions.

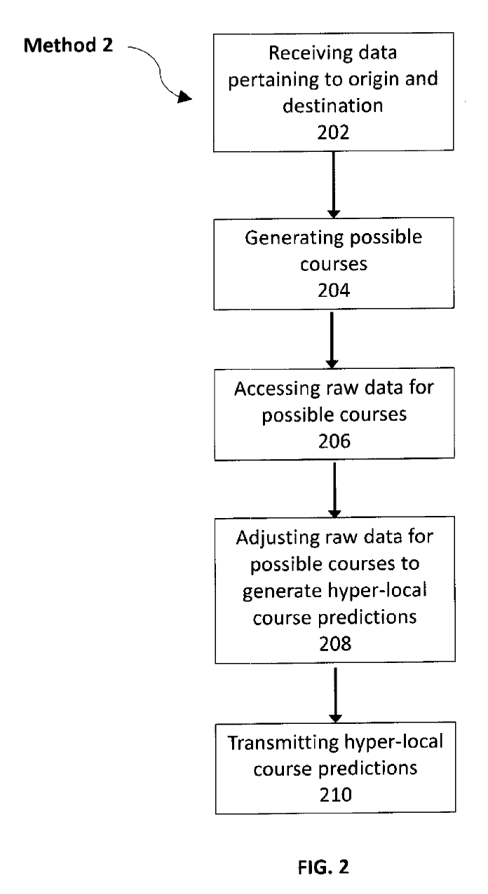

Course classifying module 300 may generate predicted course conditions by analyzing raw course data, for example, by using machine-learning techniques, and weighting the data to provide hyper-local course predictions. In some particular embodiments, artificial intelligence may be utilized by course classifying module 300. The raw course data may be adjusted, in some example embodiments, using one or more course correction factors. For example, raw course data may be adjusted based on rules generated by correlating conditions experienced by a mobile weather station with raw data for the route travelled. The mobile weather station may, in some cases, be mounted on an object (e.g., a vehicle, person, aircraft, vessel, drone, or bicycle during traversal of a course). In some example embodiments, course classifying module 300 may perform some or all of the steps of method 2 described with respect to FIG. 2. In some embodiments, course classifying module 300 may use statistical methods other than machine learning to assess risk.

Geographical features of the course (or geo location) considered may include both naturally occurring and man-made features. For example, in some embodiments, geographical features may include: street width, street size, street orientation, buildings, trees, obstructions, mountains, hills, plains, population density, climate, traffic, geo coordinates (or location, time of day, time of year, proximity to water, characteristics of proximate water, proximity to state or national parks, greenways, elevation and/or gradient. In some embodiments, a course correction factor used to generate hyper-local course (or geo location) predictions may be based on one more geographical features of the course (or geo location). By way of example, if a course includes a mountainous segment, raw weather data may be adjusted using a course correction factor specific to a mountainous region to generate hyper-local course predictions for that particular course segment. In select embodiments, a course correction factor may be based on a combination of at least two, at least three, at least four, or more geographical features of the course (or geo location). Numerous configurations and variations will be apparent.

Course classifying module 300 may generate hyper-local course predictions 400 based on the raw course data received, after adjusting for course-specific conditions. Hyper-local course predictions 400 may be, in some example, predicted outcomes for possible courses, or sections of courses. In some example embodiments, a hyper-local course prediction may be provided for a selected feature (e.g., the fastest course, safest course, or least expensive). In some embodiments, the hyper-local course predictions 400 are generated by the course classification module 300 and transmitted to the application programmable interface 200 and/or user interface 100, while in other embodiments, hyper-local course predictions may be transmitted by course classification module 300 to another module (not illustrated in FIG. 1) and then transmitted to application programmable interface 200 and/or user interface 100. In some embodiments, hyper-local course predictions 400 can be generated for possible courses using self-learning technology, based on calibrations for raw data (such as for example, environmental factors—urban or rural—wind, temperature, humidity, pressure, location, elevation). Some example calibration processes, including use of a scout vehicle to compare actual environment conditions to raw data, are described below in detail.

FIG. 2 is an exemplary method 2 of course prediction that may be performed by one or more components of the disclosed systems, in accordance with some embodiments of the subject disclosure. In some embodiments, for example, method 2 may be performed by course classification module 300. As shown in FIG. 2, example method 2 includes receiving data 202 pertaining to an origin and destination. In some examples, data pertaining to an origin and destination may be provided through the user interface 100 or by an application programmable interface 200. Method 2 continues with generating 204 possible courses. Courses may be generated (or derived) using any suitable technique. Method 2 continues with accessing 206 raw data for possible courses. Raw data may be accessed via an external source (e.g., a website or satellite) or may be accessed internally from stored information. In some example embodiments, raw data for possible courses includes predicted weather conditions, accident history, and other possibly relevant information pertaining to a particular route or course. Method 2 continues with adjusting 208 raw data for possible courses to generate hyper-local course predictions. Raw data for possible courses can be adjusted using any of the techniques described herein to produce hyper-local course predictions. Method 2 continues with transmitting 210 hyper-local course predictions. In some example embodiments, hyper-local course predictions and/or outcomes can be transmitted to an API 200 and/or directly to a user interface 100, or downloaded as data as an end point.

In some example embodiments, one or more steps of method 2 may be performed while navigating through physical space (e.g., while traversing a course). For example, during traversal of a course, other possible courses may be generated 204, raw data for these courses may be accessed 206, raw data for the courses may be adjusted 208, and/or hyper-local course predictions 210 may be transmitted, possibly along with an alert to a user, for example, indicating that the current course may include certain identified risks. In these and other embodiments, recommendations for avoiding the predicted risk on the course (or on a segment of the course) or for traversing the predicted risk on the course (or segment of the course) may be provided.

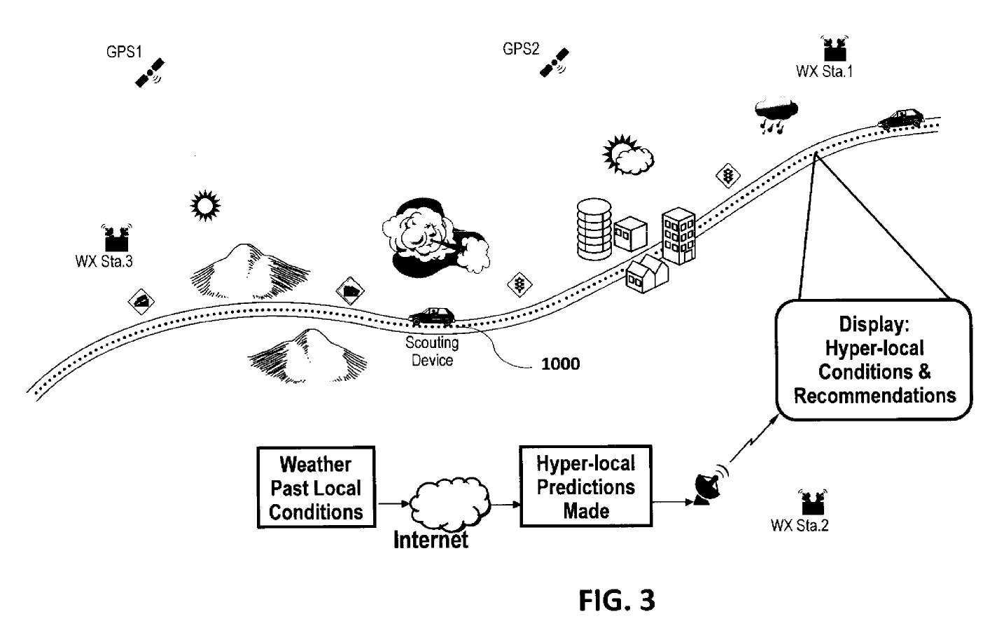

A particularly useful feature of the disclosed methods and systems is the ability to more accurately and reliably predict course conditions for particular routes. Various techniques can be employed to generate hyper-local course predictions. In some example embodiments, a scouting device can be used to evaluate and calibrate raw course data to provide more accurate predictions at points along a route. FIG. 3 shows an example scouting device 1000 traversing a route. As illustrated, scouting device 1000 is mounted on a car. However, in other embodiments, scouting device 1000 may be mounted on any type of moving object, including but not limited to a bicycle, human, boat, train, done, or spaceship. FIG. 3 illustrates scouting device 1000 traveling along a route that includes both urban and rural segments. Additionally, as illustrated, scouting device 1000 traverses a segment of the route with higher wind coverage and may calibrate environmental conditions of the route differently, depending on geographical features (man-made features, such as buildings or streets or naturally occurring features, such as mountains, hills, and bodies of water) of the route segment affects course conditions. Scouting device 1000 can, in some embodiments, receive data from various signal sources, including WXSta. 1, WXSta. 2, WXSta. 3, GPS1, and/or GPS2, as illustrated in FIG. 3. In some embodiments, data from WXSta. 1, WXSta. 2, and/or WXSta. 3 may be transmitted via GPS1 and/or GPS2. While traversing the course, scouting device 1000 may independently measure environmental conditions encountered on the route. During traversal or thereafter, environmental conditions encountered by scouting device 1000 may then be compared to environmental conditions provided by various signal sources to calibrate module 300 that provides hyper-local course predictions. Particular example methods for calibrating module 300 are explained in further detail below and at other sections of the present application and numerous variations will be apparent to one of skill in the art upon consideration of the subject disclosure.

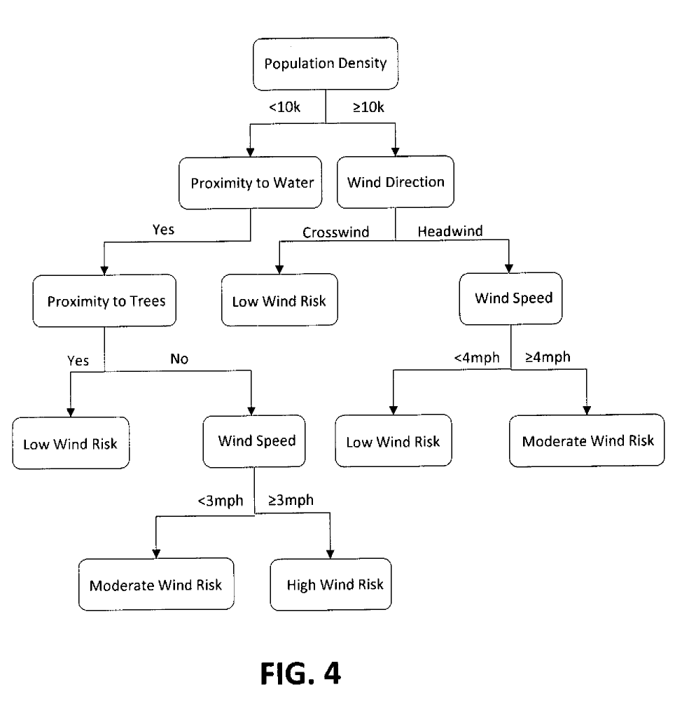

In some example embodiments, module 300 may be calibrated to apply a particular course correction factor to a course or a particular geo location based on geographical features of the course or geo location. The course correction factor may be based on one or more geographical features, including both man-made and naturally occurring geographical features. For example, in some embodiments, geographical features of a course or geo location that may be considered in selecting an appropriate course correction factor include: street width, street size, street orientation, buildings, trees, obstructions, mountains, hills, plains, deserts, population density, climate, traffic, geo coordinates or location, time of day, time of year, proximity to water, characteristics of proximate water, proximity to state or national parks, greenways, elevation, or gradient. In some embodiments, multiple geographical features are used to determine an appropriate course correction factor. In particular embodiments, a combination of at least two, at least three, at least four or more geographical features are used to determine a course correction factor. FIG. 4 shows an example decision tree that may be used by module 300 to determine an appropriate course correction factor.

As shown in FIG. 4, the population density of the course or geo location may be assessed. If population density is above or below a predetermined number (e.g., 10,000) either proximity to water or wind direction may then be assessed. Turning to cases where population density is less than 10,000 and proximity to water is assessed, if the course or geo location is proximate to water (e.g., within 1,000 yards), proximity to trees may then be assessed. If it is determined that the course or geo location is proximate to trees (e.g., within 1,000 yards), a course correction factor for low wind risk may be applied to raw course data. If, however, the course or geo location is not proximate to trees, wind speed may then be assessed. If wind speed is less than a predetermined value (e.g., 3 mph), a course correction factor for moderate wind risk may be applied. If, however, wind speed is greater than or equal to the predetermined value (in this case, 3 mph), a course correction factor for high wind risk may be applied. Turning to cases where population density is greater than or equal to a predetermined value (e.g., 10,000), a different feature of the course of geo location may be assessed, in this case wind direction. If crosswind is present, a course correction factor for low wind risk may be applied, whereas if headwind is present, wind speed may then be assessed. If wind speed is less than a predetermined value (e.g., 4 mph), a course correction factor for low wind risk may be applied. In cases where wind speed is greater than or equal to a predetermined value (in this case, 4 mph), a course correction for moderate wind risk may be applied. As will be understood, numerous possible decision trees for assigning appropriate course correction factors are contemplated and the subject disclosure is not intended to be limited to the example decision tree shown in FIG. 4.

In some embodiments, the disclosed systems may be used by individual users by interacting with user interface 100. In some example embodiments, the user interface 100 makes calls to the API 200, as third party software applications are capable of doing. In some embodiments, API 200 can call on various nodes; such as Environmental Data Acquisition (EDA), Route Derivation (RD), and Collective Emergent Patterns (CEP). In some such example embodiments, the route derivation may first be called, which then makes API calls to external services that derive a route. The route may then be returned as a list of waypoints that contain latitude and longitude pairs, elevation, and/or distance traveled from the origin. Next, multithreading techniques may be used to call the environmental data acquisition for each waypoint along the route. Parallel computing may be used to gather this information quickly, in some example embodiments. Each waypoint returns a list of environmental data. This data may be stored in any suitable database, including in the cloud. Finally, the collective emergent patterns are called, which act on the stored data to predict features of the possible routes. In some example embodiments, predicted features of possible routes may be returned as a classification in the form of color-coded groups along the route. Each group may, in some cases, be paired with an alert and action text, as desired. User interface 100 may display this information in any suitable form, such as an interactive map, in some example embodiments.

The disclosed systems and methods may utilize waypoint nodes, in some embodiments. For example, waypoint nodes may be returned after possible routes are derived. In each waypoint node, a list of parameters may be returned that define the geographical characteristics of points along the route. These variables can be sampled, and in some cases, may be regularly or irregularly sampled. Interpolation techniques may then be applied to the possible routes. In some cases, interpolation techniques are applied to evenly divide the distance between waypoints. Regularly spaced waypoints can provide the framework for Environment Data Acquisition, which utilizes proximity calculations to distinguish between relatively spaced weather stations. Each equidistant waypoint node may, in some embodiments, contain the following parameters: latitude, longitude, elevation, distance, and/or address.

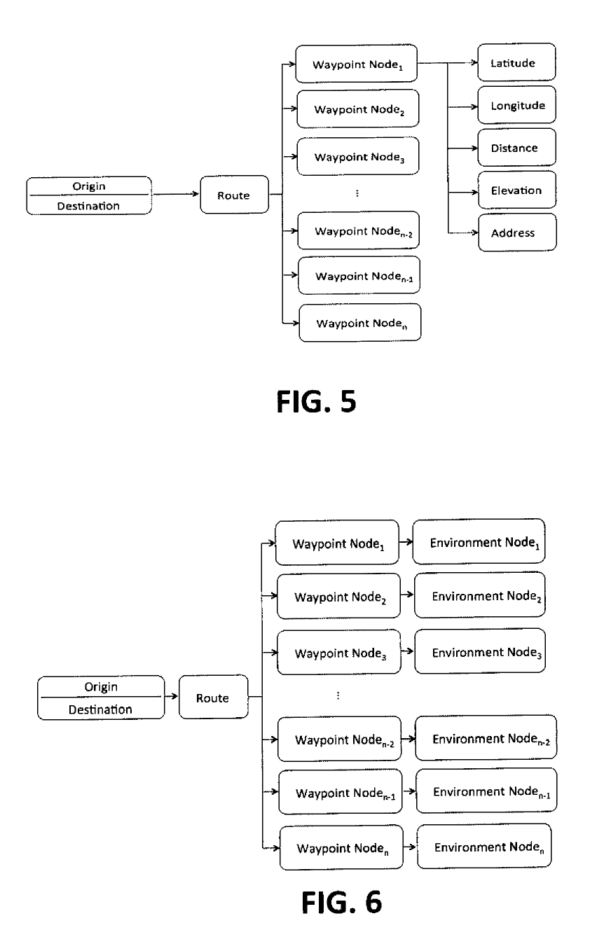

A listing of waypoints may include at least two inputs, which, in some cases are a start location (origin) and a finish location (destination). These inputs can be formatted as GPS coordinates, an address, town/city, or place of interest. Possible routes containing a list of waypoint nodes and their associated parameters may then be produced. An example illustration of the derivation of waypoint nodes for a particular route (or course) is shown in FIG. 5.

In accordance with some example embodiments, the disclosed methods and systems may also utilize environment nodes, as described in detail below and as illustrated in FIG. 6. Environment nodes may be built from the list of waypoints for a particular course, or route. For example, at each waypoint node, data pertaining to environmental circumstances (e.g., temperature, wind speed, humidity, dew point, etc.) may be retrieved. In some cases, environmental data may be received from an external service, such as wearable technology, handheld devices, personal and public weather stations, and/or meteorological forecast (external) APIs, or directly from the National Weather Service. Environment nodes for each waypoint may then be produced. Each environment node may contain the following information regarding weather and environmental conditions: request time, weather summary, precipitation intensity, precipitation probability, ozone levels, cloud cover, temperature, dew point, humidity, barometric pressure, wind speed, wind bearing, sunset, and/or sunrise.

The disclosed systems can, in some embodiments, handle multiple user requests simultaneously. In some example embodiments, requests may be prioritized according to scoring methods to determine high-risk scenarios along a route. In some such embodiments, users who may encounter higher-risk segments in their routes may be processed before users who have less risk associated with their route. Prioritization may, in some circumstances, provide a more efficient user experience for high risk events or courses.

Previous systems merely report weather as it passes through a static (fixed) location. While the disclosed techniques may also be used to predict hyper-local predictions for a fixed geo location, the disclosed techniques, can also interpolate and calibrate points along a route. For example, in some embodiments, dynamic calculations while a user is in motion may be used to predict risk and to provide a more optimal method for reaching the destination. In addition, the disclosed techniques and systems may combine weather and environmental data with geographical features into a route navigation system. The disclosed systems can, in some embodiments, derive a highly accurate dataset from calibration of these interpolated values using a measurement device fixed on vehicles, bicycles, or people (for example, scouting device 1000 shown in FIG. 3). Using this device or a variant thereof, the disclosed systems can measure the difference in weather information and road conditions along a route caused by geographical features and develop calibration equations that correct the data at each interpolated point. In addition, the highly calibrated data can provide directional information for a vehicle or person in the absence or in addition to information/services.

No previously available system includes a method for calculating risks affected by weather while a user is in motion, or providing high resolution weather data as a means for navigation. Rather, previously available systems only include the movement of weather relative to a fixed object or position and do not include the effect of movement through the physical space. Moreover, previously available systems do not include the effect of geographical features or calibration sequences. In some embodiments, calibrated data of the disclosed systems and methods can be referenced in the form of a map, providing an additional resource to navigation services (for example, in methods that require high precision such as autonomous vehicles or drone navigation).

The disclosed systems and methods may include collection of environment data within an environment node. The environment data in each environment node may, in some cases, originate from several data sources, such as personal weather stations, public weather stations, and/or meteorological forecast APIs. Filtering and calibration factor adjustments can be used to account for some variability among interpolated waypoint markers. In some example embodiments, data from surrounding data sources can be aggregated together and a mesh calibration may be used to create highly accurate hyper-local environment data, and classify wind and other weather data, in some embodiments. As mesh calibrations are not always enough to solidify accurate predictions, geographical features and social media input or natural language processing may also be used. Mesh calibration may be used to align environment data from one geographical location to the next. In some cases, mesh calibration can produce a consistent environment prediction system for variables, including course conditions, such as road condition, precipitation, wind speed/direction, and/or elevation.

The disclosed mesh calibration and prediction techniques may also take environment data within context. In particular, not all environment data should be treated equal. For example, environment data stemming from mountainous regions have a different effect than data from coastal regions. Wind speed and direction may also be affected by these geographical features. Taking this information into account, the disclosed methods provide more accurate calibration and prediction techniques that are specific to a geographic region and its surrounding features (e.g., topology, buildings, environment, and the like). The disclosed techniques can, in some cases, be used to determine past, current, and/or future conditions.

Social media input (from platforms such as Twitter, Instagram, and/or Facebook) and other unstructured sources, such as media outlets, or natural language processing can be utilized to validate the disclosed methods, in some example embodiments. While social media need not be used to calibrate or prescribe environmental conditions, it may give a validation warning if the system's output conflicts with social media and posts. The data and calibration factors may then automatically be assessed and sometimes reapplied, if appropriate.

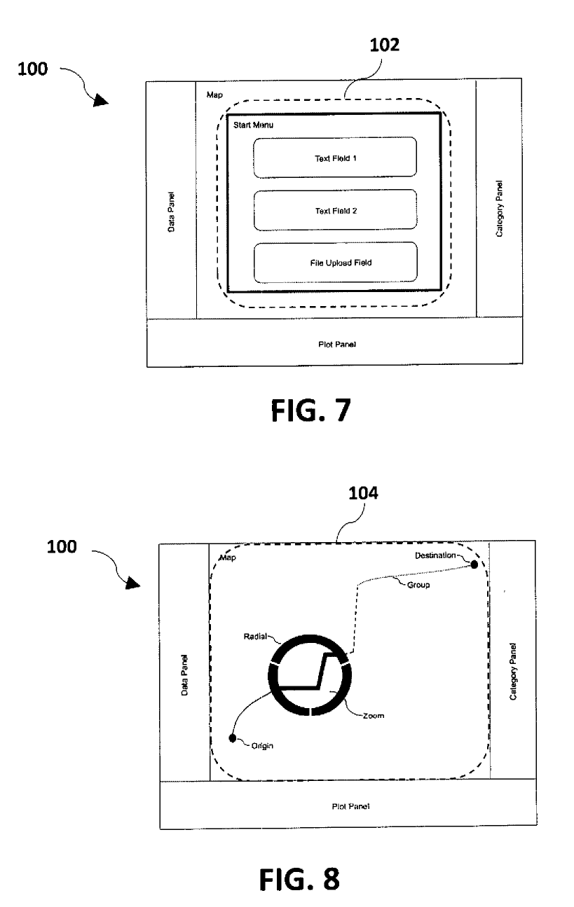

The disclosed methods and systems can operate in a cloud based environment, with visualization aspects and user interface capabilities residing on the Internet or on Mobile Device Applications. The web page or mobile device application may be designed for an interactive user experience, in some example embodiments. In some cases, the user interface 100 may include a start menu 102, where a user can enter an origin and may enter a destination into text fields. FIG. 7 shows an example user interface 100 displaying a start menu 102 that includes text field 1, where an origin may be entered, and text field 2, where a destination may be entered. Start menu 102 may also include a file upload field, as illustrated in FIG. 7, where a file containing geo-coordinates may be uploaded instead of or in addition to a typed origin and destination. In some instances, the data collected while a user traverses a course in physical space may not have a destination, and the information collected, calibration, and prediction can help predict the destination of the user.

User interface 100 may also, in some embodiments, include a map 104. In some embodiments, map 104 may reside in approximately the center of the screen of a user interface 100. Map 104 may display numerous features of a course, including groups (or classifications), radial visualization, and/or zoom capabilities within the radial. Information along a route (or course) is shown as “groups,” which are segments along the course from origin to destination that are grouped based on selected categories. Groups (alternatively referenced herein as “classifications”) may be shown in different colors or by different types of line to differentiate between groups. Groups may be determined using any suitable technique, including by assigning scores to points along the route and grouping sections of the route with similar scores into the same group. In some embodiments, a user may select a category panel (shown in FIG. 8) to determine how groups are assigned. In some embodiments, one category or more than one category can be used to assign groups along the route. For example, when an origin and destination are provided, one or more possible courses are derived, and weather conditions are predicted at various points along a course. The predicted weather conditions along the course may indicate that the following sections of the route are at high risk for a high or low wind condition, depending on features in that geographic location:

Grouping 1: mile 0 to 26.4

Grouping 2: mile 57.3 to 76.6

Grouping 3: mile 108.1 to 127.9

In some embodiments, the analysis of segments (groups/classifications) of the route that may be at risk for adverse travel conditions may take place in the cloud and the sections of the route that are at risk for adverse travel conditions may be sent to the user interface. Information regarding adverse travel conditions may be provided to the user interface by any appropriate technique, including by showing that portion of the route in a different color (e.g., red) or with words (e.g., “high wind”). In some embodiments, the user interface may also indicate whether the grouping (section of the route) is high risk, low risk, or moderate risk. In these and other embodiments, the user interface may advise a user to take certain precautions or actions (e.g., ‘slow down to less than 10 mph,’ or ‘turn fog lights on’).

In some embodiments, map 104 may also include radial visualization displays for categories of data selected by a user. Radial visualization displays may include, for example, temperature, precipitation, and/or wind speed. The radial can display curved plots representing the value of each parameter for the group that the user is currently investigating. In some embodiments, the radial may be equipped with zoom functionality, which can magnify some portions or all of the route.

As shown in FIG. 8, panels can also be shown on map 104. Panels can be configured to open or close, in some embodiments. In some cases, one of the panels is a data panel that houses environment data for each node along the route. Upon selection of a point on the route, the data for the applicable node may be displayed. In some embodiments, a user can select or deselect one or more variables to be displayed in the radial. The user may, if desired, also select a combination of variables to be displayed in a plot panel. If utilized, a plot panel can display a time or distance series line plot of variables selected in the data panel (e.g., elevation vs time or elevation vs distance). Groups may be color-coded according to the area under the line plot. A category panel may also be present, which lists all of the categories being evaluated. For example, fuel efficiency, route completion time, route safety prediction, high wind advisory, etc. may be selected as possible categories to calculate groups along the route.

The disclosed example methods and systems may, in some embodiments, apply environment data along a route to calculate groups. In some example embodiments, groups may represent information to alert a user regarding safety and/or performance along a given route. Groups may be determined based on one or more derivations. Example information that may be used as a derivation includes but is not limited to: gradient, gradient group, heading (direction in which the vehicle's foremost point is oriented), through time, heat index, wet bulb globe temperature, road conditions, air density, relative wind direction, relative wind speed, aerodynamic drag, fuel efficiency, cold index, ice risk, performance score, traffic index, and/or time index.

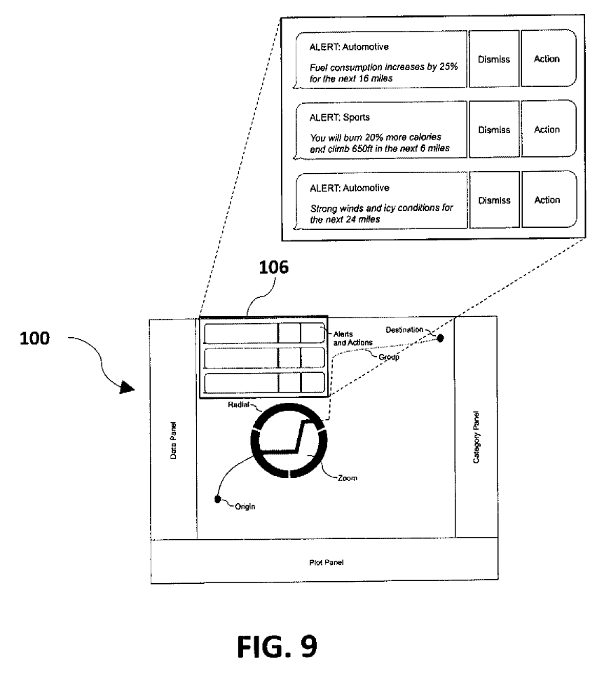

In some embodiments, the disclosed systems may be configured to provide alerts and/or actions to a user. Alerts or actions may be provided as text that appears on the user interface, for example, over the map. In some embodiments, alerts and actions may be provided based on groupings, with alerts and/or actions being tailored to a particular group. Alerts can make a user aware of relevant or critical information about the group. In some embodiments, a user may dismiss an alert or may request action. Requesting action can depend on a given alert, for example, slowing down to decrease air resistance to conserve fuel or, in other cases, selecting an alternative route. FIG. 9 shows an example map 104 displaying an alert message 106.

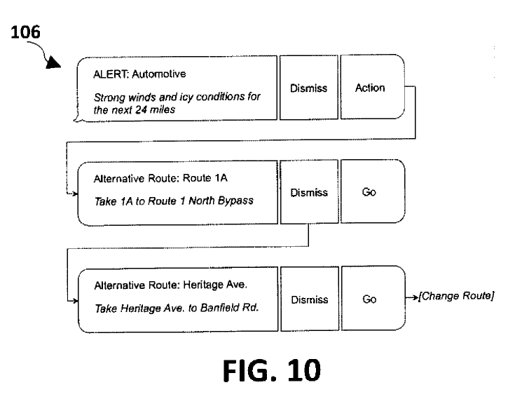

Alert messages 106 can be displayed at any desired location on a user interface 100. For example, as shown in FIG. 9, alerts and/or actions can by displayed in an upper left hand corner over map 104. When activated, an alert can be displayed along with other features, including dismiss or action options. In some particular embodiments, an alert display message can include a title, an alert message, a dismiss button, and an action button. An example alert message 106 is shown in FIG. 10. As shown in FIG. 10, the action button, when utilized, can provide a listing of options for the user to select.

In some embodiments, actions may have associated behavior changes. In some such embodiments, when a user selects a behavior change associated with an action, the user interface may reload with new or updated information. Example behavior changes include derivation of a new route and/or calculation of new groups, and in some cases a calculation of a new destination.

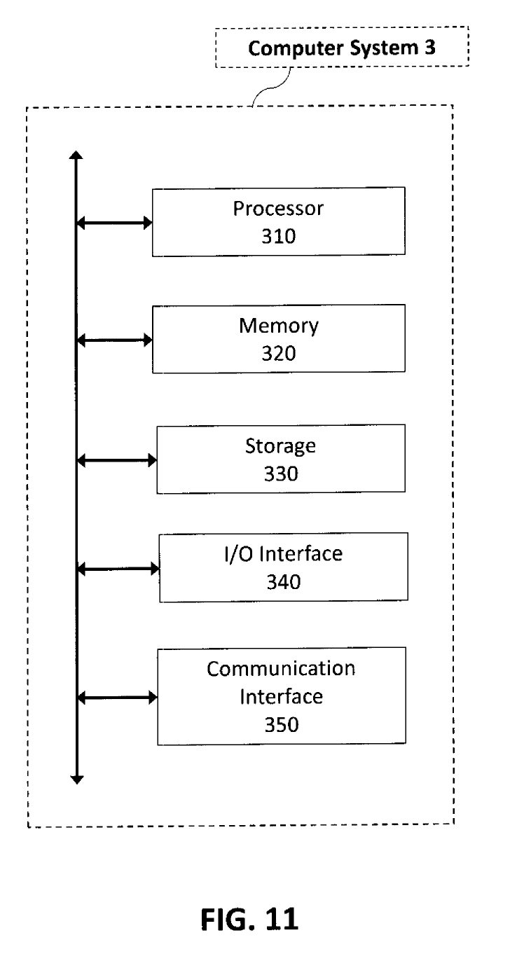

FIG. 11 illustrates an example computer system 3 that may be used in some embodiments to perform some or all steps of the disclosed methods. This disclosure contemplates any suitable number of computer systems 3. In some embodiments, computer system 3 includes a processor 310, memory 320, storage 330, an input/output (I/O) interface 340, and/or a communication interface 350. In particular embodiments, processor 310 includes hardware for executing instructions, such as those making up a computer program. As an example and not by way of limitation, to execute instructions, processor 310 may retrieve (or fetch) instructions from an internal register, an internal cache, memory 320, or storage 330; decode and execute the instructions; and then write one or more results to an internal register, an internal cache, memory 320, of storage 330. In particular embodiments, processor 310 may include one or more internal caches for data, instructions, and/or addresses.

In particular embodiments, memory 320 includes main memory for storing instructions for processor 310 to execute or data for processor 310 to operate on. As an example and not by way of limitation, computer system 3 may load instructions from storage 330 or another source (such as, for example, another computer system 3) to memory 320. Processor 310 may then load the instructions from memory 320 to an internal register or internal cache. To execute the instructions, processor 310 may retrieve the instructions from the internal register or internal cache and decode the instructions. During or after execution of the instructions, processor 310 may write one or more results (which may be intermediate or final results) to the internal register or internal cache. Processor 310 may then write one or more of those results to memory 320. One or more memory buses (which may each include an address bus and a data bus) may couple processor 310 to memory 320. If present, a bus may include one or more memory buses. In particular embodiments, one or more memory management units (MM Us) reside between processor 310 and memory 320 to facilitate accesses to memory 320 requested by processor 310. In particular embodiments, memory 320 includes random access memory (RAM). This RAM may be volatile memory, where appropriate. In some circumstances, where appropriate, this RAM may be dynamic RAM (DRAM) or static RAM (SRAM). In some embodiments memory 320 may encompass one or more storage media and may, generally, provide a place to store computer code (e.g., software or firmware) and data that used by a computing platform. By way of example, memory 320 may, in some embodiments, include various tangible computer-readable storage media including Read-Only Memory (ROM) or Random-Access Memory (RAM).

In particular embodiments, storage 330 includes mass storage for data or instructions. As an example and not by way of limitation, storage 330 may include an HDD, a floppy disk drive, flash memory, an optical disc, a magneto-optical disc, magnetic tape, or a Universal Serial Bus (USB) drive or a combination of two or more of these. Where appropriate, this ROM may be mask-programmed ROM, programmable ROM (PROM), erasable PROM (EPROM), electrically erasable PROM (EEPROM), electrically alterable ROM (CAROM), or flash memory or a combination of two or more of these.

In particular embodiments, interface 340 includes hardware, software, or both providing one or more interfaces for communication between computer system 3 and one or more I/O devices. Computer system 600 may include one or more of these I/O devices, where appropriate. One or more of these I/O devices may enable communication between a user and computer system 3. Where appropriate, I/O interface 340 may include one or more device or software drivers enabling processor 310 to drive one or more of these I/O devices. I/O interface 340 may include one or more I/O interfaces 340, where appropriate.

In particular embodiments, communication interface 350 includes hardware, software, or both providing one or more interfaces for communication (such as, for example, packet-based communication) between computer system 3 and one or more other computer systems 3 or one or more networks. As an example and not by way of limitation, communication interface 350 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 350 for it.

As will be understood, in some cases a specific performance device, as opposed to a general purpose computer, may be employed to perform the disclosed methods. Furthermore, in some example embodiments, the disclosed systems include one or more computer-readable non-transitory storage media embodying software that is operable when executed to perform any of the disclosed methods. The disclosed methods and systems, may, in some example embodiments, improve the employed hardware and/or software.

The disclosed methods and systems provide numerous benefits as compared to currently available route navigation tools. For example, the disclosed methods and systems can alert a user as to why there is a risk along specific segments of a route and then helpfully provide an alert and/or action of detailed information about the risk and how to avoid it or negotiate through it (e.g., by adjusting speed, acceleration, altitude, or other travel techniques). As previously explained in detail, the disclosed methods and systems may calculate a risk score per segment of a route, and also alert a user as to how to reduce the risk along certain segments of the route. The length of the route segment can be determined by the risk score. The disclosed systems are thus capable of calculating risk and predicting safer and more efficient paths for travel, or determine new paths of travel.

Features of the present disclosure can be used in a wide variety of applications, some of which are discussed herein. For example, the disclosed techniques could be applied to Physics in Motion applications. As will be understood, while traveling along a route, the environment can impact a vehicle's performance. The disclosed methods and systems, may, in some embodiments, utilize equations of motion such as aerodynamic resistance, gravity, or rolling friction to determine how the vehicle performs in that environment. The system may then, if desired, alert a user how likely the following incidents are to occur: for there to be an accident, to run out of fuel, or to miss an appointment, or to run off course. The disclosed methods and systems could also be used for Nowcasting applications. It is understood that weather and environmental information is more accurate at times closer to a given moment. Nowcasting can provide highly accurate data in real time, which may be provided to a user upon request and visualized to help the user make better decisions. Additionally, the disclosed techniques may also be applied to mesh forecasting. For example, there are many gaps between data points in current weather and environmental analysis, but the disclosed techniques can create an interpolated mesh that gives hyperlocal information where data is missing. This mesh may be calibrated and corrected based on geographical features and contextual elements in three-dimensional space and may be overlaid on maps with other contextual information.

The disclosed techniques and devices may also be used in aftcasting applications. The ability to analyze performance is crucial and can help the disclosed systems become more accurate. Aftcasting records data such as weather, which is stored and is analyzed later. The post analysis can possibly improve the accuracy of the disclosed systems, for example, by allowing a user to analyze current performance or to perfect their future performance. The disclosed methods and systems may also integrate into GPS navigation systems to enhance the output and provide crucial information to the user. The integration can include access to API(s) 200 and user database that may become embedded the GPS' mapping environment and may, in some cases, provide insight to systems and methods requesting information, such as insurance companies.

Traffic and congestion along a route can sometimes be heavily reliant on external factors such as weather, road construction, or other obstructions. The disclosed methods and devices may, in some embodiments, better alert users regarding whether they are likely to encounter delays via calculations of the described external factors. In some such embodiments, high risk scenarios can be calculated via the described scoring system. As more data is collected using the disclosed techniques, data scientists and analysts may desire analysis tools to dissect the weather and environment data. The disclosed modules and methods may provide analysis and visualization tools for this and possibly other purposes. These tools include software development platforms that allow a user to create customized scripts and dashboards of graphs and visualizations as well as use a core set of graphical animations of the data provided by the system.

Additionally, the disclosed techniques could be used as crowd-sourced media data that may give heads up information as to what may occur or what is occurring along a route which will inform a user's planning of a trip. Predictive analytics using humans as sensors could also empower users to calculate better means of travel. With a high-resolution mesh of information, the disclosed systems could allow for a 3D user experience and analysis package. For example, using the disclosed user interface 100 and statistical tools, a 3D dataset may be used to provide an interface that works in three dimensions.

The disclosed features may also be used as a data repository. For example, the data acquired via user interactions may be stored and managed so that it can be reused for analysis and other possible purposes. This database can, in some cases, be accessible by users directly or via API calls. Yet another possible use for the disclosed features is for mobile weather meter applications. For example, mobile weather meters may help build a more accurate dataset by including calibration features impacted by geographical elements, such as buildings, trees, and mountains along a route. The analysis performed by the disclosed system may produce a highly accurate and flexible weather meter. The weather meter could, in some cases, be a stand-alone wearable or mountable device that includes a central processing unit, sensors, memory storage, and/or a battery housed in an enclosure.

In addition to other features, the described methods and systems may provide a user with more up-to-date information regarding course conditions during travel. In particular, the way the system operates can allow for quicker and more efficient processing of data without additional memory usage. For example, the system's ability to assess travel risk for various course segments, then group course segments with similar risk profiles together and transmit this information to a user can result in more timely updates pertaining to course conditions, which could improve user safety and/or performance when traversing a course. Additionally, in some embodiments, a course may have an unspecified destination and data collected while a user traverses the course may be used by the course classification module to predict a destination.

As will be understood upon consideration of the subject disclosure, the methods and systems described in the subject application may provide unique advantages for particular applications. For example, the disclosed methods and systems may be useful in autonomous vehicles, drones, sports, and/or fleet management applications. In some such embodiments, the systems may capture weather-related events to improve cost savings through fuel efficiency and fleet safety. Additionally, the described methods can provide the ability to track and manage driving patterns during inclement weather conditions.

Furthermore, for autonomous vehicles, which require sensing of an environment to navigate without human input, the disclosed methods and systems may provide environmental information to allow or improve route traversal. For example, the disclosed systems may be used to provide an autonomous vehicle with hyper-local weather data for a route that reflects actual conditions of the road, thereby giving a self-driving or autonomous vehicle the ability to act rather than react to possibly dangerous road conditions. In some embodiments, a system as described herein may be configured for use by an autonomous vehicle, and may instruct the vehicle to take a particular action when certain road conditions are predicted. For example, an autonomous vehicle may be instructed to reduce speed to less than 30 mph if wet, snowy, or icy road conditions are predicted. Additionally, in some cases, information of particular environmental conditions could enable autonomous vehicles to travel on previously inaccessible routes. For example, autonomous vehicles cannot currently safely and reliably traverse bridges. However, it is contemplated that providing an autonomous vehicle with the disclosed course prediction methods and systems, such as wind data for a course, could allow autonomous vehicles to traverse previously inacessible routes, such as bridges. Numerous configurations and variations will be apparent to one of skill in the art upon consideration of the subject disclosure.

### Examples

The following section includes various illustrative example embodiments, but is not intended to limit the disclosure to the identified embodiments described herein.

In a first example embodiment, a system for generating hyper-local course predictions is provided that includes a computing device having a processor, a non-transitory memory, and at least one database. In this embodiment, the system also includes a course classification module configured to aggregate raw data pertaining to the course and apply at least one course correction factor to the raw data pertaining to the course, using the processor, to generate hyper-local course predictions, wherein the raw data pertaining to the course includes weather data and the at least one course correction factor used to generate hyper-local course predictions is determined based on at least one geographical feature of the course or a segment of the course. In this and other example embodiments, the at least one geographical feature is man-made or naturally occurring. In these and other example embodiments described in this paragraph, the course classification module generates alert notifications of predicted risks for traveling a course from an origin to a destination or from an origin to an unspecified destination. In these and other example embodiments, the course classification module is used in connection with an autonomous vehicle and the course classification module generates hyper-local course predictions pertaining to road surface and/or wind conditions along the course. In these and other example embodiments described in this paragraph, the course classification module is used in connection with a drone device and the course classification module generates hyper-local course predictions pertaining to wind speed along the course. In these and other example embodiments described in this paragraph, a wind sensor is mounted to the vehicle or device, wherein the wind sensor senses wind speed and/or wind direction, and measured wind conditions are transmitted to the course classification module and compared to the generated hyper-local course predictions to confirm that the vehicle or device is on course, to indicate that a course correction is needed, or calculate velocity or distance. In these and other example embodiments described in this paragraph, the course classification module is calibrated by a mobile scouting device that measures differences in predetermined parameters along the course caused by geographical features and utilizes the measured differences to determine the course correction factor. In these and other example embodiments described in this paragraph, the course classification module is further configured to provide mesh forecasting by generating hyper-local course conditions in one or more course segments and the hyper-local course conditions are displayed on a user interface overlaid on maps, along with other contextual information pertaining to the course, or transmitted to an application programmable interface. In these and other example embodiments described in this paragraph, the course classification module calculates risk assessment values for one or more segments of the course and transmits the risk assessment values to an application programmable interface or a user interface. In these and other example embodiments described in this paragraph, the risk assessment values calculated are grouped by severity into classifications that include course segments with similar risk. In these and other example embodiments described in this paragraph, an alert advising a user to select an alternate course segment or a new destination is sent to the user interface or transmitted over an application programmable interface if a classification has a risk severity that exceeds a predetermined threshold. In these and other example embodiments described in this paragraph, the course has an unspecified destination and data collected while a user traverses the course may be used by the course classification module to predict a destination. In these and other example embodiments described in this paragraph, wherein the hyper-local course predictions are used in a route navigation system. In these and other example embodiments described in this paragraph, the aggregated data includes a 3-D dataset. In these and other example embodiments described in this paragraph, the one or more hyper-local geo location predictions are verified using social media data or natural language processing.

In another example embodiment, a system is provided for calculating a risk score for a segment of a course along which a user is traversing. In this example embodiment, the system is configured to continuously provide updates regarding how to improve traversing the segment, given risk alerts associated with the segment, and the system is also configured to provide the user with the risk score so as to permit the user to alter activity while traveling the course. In this and other example embodiments, the system further includes a measuring device configured to measure parameters relating to the course segment and to calibrate aggregated data to closely correspond to the measured parameters. In these and other example embodiments, the measuring device includes a mobile weather meter to assist in calibrating the aggregated data by taking into account calibration features, including geographical features that exist along the course segment. In these and other example embodiments, the risk scores are calculated taking into account hyper-local weather conditions derived from weather forecasting and corrected based on geographical features of the course. In these and other example embodiments described in this paragraph, the system further includes predictive analytics that takes into account the calculated risk score to provide suggestions to improve traversing the course. In these and other example embodiments described in this paragraph, the system is capable of servicing multiple users simultaneously, and is configured to prioritize updates for users who may encounter a higher-risk segment. In these and other example embodiments described in this paragraph, the risk score includes the probability that a predetermined risk is likely to occur and the predetermined risk includes at least one of impaired safety, efficiency, or performance. In these and other example embodiments described in this paragraph, the risks are grouped in terms of severity and are transmitted to a user interface or through an application programmable interface.

In a further example embodiment, a system for generating one or more hyper-local geo location predictions is provided. In this embodiment, the system includes a computing device having a processor, a non-transitory memory, and at least one database. The system also includes a course classification module configured to aggregate raw data pertaining to the geo location and apply at least one course correction factor to the raw data pertaining to the geo location, using the processor, to generate one or more hyper-local geo location predictions, wherein the raw data pertaining to the geo location includes weather data and the at least one course correction factor used to generate one or more hyper-local geo location predictions is determined based on at least one geographical feature of the geo location. In this and other example embodiments, the at least one geographical feature is man-made or naturally-occurring.

The features and advantages described herein are not all-inclusive and, in particular, many additional features and advantages will be apparent to one of ordinary skill in the art in view of the drawings, specification, and claims. Moreover, it should be noted that the language used in the specification has been selected principally for readability and instructional purposes, and not to limit the scope of the inventive subject matter described herein. The foregoing description of the embodiments of the disclosure has been presented for the purpose of illustration; it is not intended to be exhaustive or to limit the claims to the precise forms disclosed. Persons skilled in the relevant art can appreciate that many modifications and variations are possible in light of the above disclosure.

1. A system for generating hyper-local course predictions, the system comprising:
a computing device having a processor, a non-transitory memory, and at least one database; and
a course classification module configured to aggregate raw data pertaining to the course and apply at least one course correction factor to the raw data pertaining to the course, using the processor, to generate hyper-local course predictions, wherein the raw data pertaining to the course includes weather data and the at least one course correction factor used to generate hyper-local course predictions is determined based on at least one geographical feature of the course or a segment of the course.

2. The system of claim 1, wherein the at least one geographical feature is man-made or naturally occurring.

3. The system of claim 1, wherein the course classification module generates alert notifications of predicted risks for traveling a course from an origin to a destination or from an origin to an unspecified destination.

4. The system of claim 1, wherein the course classification module is used in connection with an autonomous vehicle and the course classification module generates hyper-local course predictions pertaining to road surface and/or wind conditions along the course.

5. The system of claim 1, wherein the course classification module is used in connection with a drone device and the course classification module generates hyper-local course predictions pertaining to wind speed along the course.

6. The system of claim 4 further comprising a sonic wind sensor mounted to the vehicle or device, wherein the sonic wind sensor senses wind speed and/or wind direction, and measured wind conditions are transmitted to the course classification module and compared to the generated hyper-local course predictions to confirm that the vehicle or device is on course, to indicate that a course correction is needed, or calculate velocity or distance.

7. The system of claim 1, wherein the course classification module is calibrated by a mobile scouting device that measures differences in predetermined parameters along the course caused by geographical features and utilizes the measured differences to determine the course correction factor.

8. The system of claim 1, wherein the course classification module is further configured to provide mesh forecasting by generating hyper-local course conditions in one or more course segments and the hyper-local course conditions are displayed on a user interface overlaid on maps, along with other contextual information pertaining to the course, or transmitted to an application programmable interface.

9. The system of claim 1, wherein the course classification module calculates risk assessment values for one or more segments of the course and transmits the risk assessment values to an application programmable interface or a user interface.

10. The system of claim 9, wherein the risk assessment values calculated are grouped by severity into classifications that include course segments with similar risk.

11. The system of claim 10, wherein an alert advising a user to select an alternate course segment or a new destination is sent to the user interface or transmitted over an application programmable interface if a classification has a risk severity that exceeds a predetermined threshold.

12. The system of claim 1, wherein the course has an unspecified destination and data collected while a user traverses the course may be used by the course classification module to predict a destination.

13. The system of claim 1, wherein the hyper-local course predictions are used in a route navigation system.

14. The system of claim 1, wherein the aggregated data includes a 3-D dataset.

15. The system of claim 1, wherein the one or more hyper-local geo location predictions are verified using social media data or natural language processing.

16. A system for calculating a risk score for a segment of a course along which a user is traversing, the system configured to continuously provide updates regarding how to improve traversing the segment, given risk alerts associated with the segment, the system also configured to provide the user with the risk score so as to permit the user to alter activity while traveling the course.

17. The system of claim 16 further comprising a measuring device configured to measure parameters relating to the course segment and to calibrate aggregated data to closely correspond to the measured parameters.

18. The system of claim 17, wherein the measuring device includes a mobile weather meter to assist in calibrating the aggregated data by taking into account calibration features, including geographical features that exist along the course segment.

19. The system of claim 16, wherein the risk scores are calculated taking into account hyper-local weather conditions derived from weather forecasting and corrected based on geographical features of the course.

20. The system of claim 16 further comprising predictive analytics that takes into account the calculated risk score to provide suggestions to improve traversing the course.

21. The system of claim 20, wherein the system is capable of servicing multiple users simultaneously, and is configured to prioritize updates for users who may encounter a higher-risk segment.

22. The system of claim 16, wherein the risk score includes the probability that a predetermined risk is likely to occur and the predetermined risk includes at least one of impaired safety, efficiency, or performance.

23. The system of claim 22, wherein risks are grouped in terms of severity and are transmitted to a user interface or through an application programmable interface.

24. A system for generating one or more hyper-local geo location predictions, the system comprising:
a computing device having a processor, a non-transitory memory, and at least one database; and
a course classification module configured to aggregate raw data pertaining to the geo location and apply at least one course correction factor to the raw data pertaining to the geo location, using the processor, to generate one or more hyper-local geo location predictions, wherein the raw data pertaining to the geo location includes weather data and the at least one course correction factor used to generate one or more hyper-local geo location predictions is determined based on at least one geographical feature of the geo location.

25. The system of claim 24, wherein the at least one geographical feature is man-made or naturally-occurring.
